(19) United States
(12) Patent Application Publication
(10) Pub. No.: US 2002/0011542 A1
(43) Pub. Date: Jan. 31, 2002

(54) Self-clinching hybrid fastener

(76) Inventor: George R. Winton III, Lawrenceville, GA (US)

Correspondence Address: STAAS & HALSEY LLP, 700 11TH STREET, NW, SUITE 500, WASHINGTON, DC, 20001, US

(21) Appl. No.: 09/915,592

(22) Filed: Jul. 27, 2001

Related U.S. Application Data
(60) Provisional application No. 60/221,535, filed on Jul. 28, 2000.
(60) Provisional application No. 60/221,537, filed on Jul. 28, 2000.
(60) Provisional application No. 60/222,211, filed on Aug. 1, 2000.

(51) Int. Cl. F16B 15/00; F16L 3/00

(52) U.S. Cl. 248/74.1; 248/73

(57) ABSTRACT

A fastener to provide an anchor point for a wire and to be fastened to a sheet panel, comprising a self-clinching base made of a first material, to self-clinch to the sheet panel and a fastener section attached to the self-clinching base and made of a second material different from the first material, to secure the wire.

### CROSS-REFERENCE TO RELATED APPLICATIONS

This application claims the benefit of U.S. Provisional Application Nos. 60/221,535, filed Jul. 28, 2000; 60/221,537, filed Jul. 28, 2000; and 60/222,211, filed Aug. 1, 2000 in the U.S. Patent & Trademark Office, the disclosures of which are incorporated herein by reference.

### BACKGROUND OF THE INVENTION

1. Field of the Invention

The present invention relates to hardware that retains a wire or wire bundles inside sheetmetal enclosures. More particularly, the present invention relates to a self-clinching fastener which self-clinches to a supporting sheet panel and retains a wire or wire bundle.

2. Description of the Related Art

In the design of sheetmetal enclosures, it is common to secure a wire or wire bundles with self-adhesive fasteners. These self-adhesive fasteners are often placed in key positions in an effort to support a single wire or several wires. These fasteners help ensure that the wire and/or wire bundles stay clear of various devices including moving parts and areas of high temperature. Further, these fasteners improve the neatness and provide a more visually pleasing apparatus.

The down side of the existing fasteners is the adhesive backing. Quite often, the adhesive backing will become separated from a supporting sheet panel. A chief cause of this failure is the temperature variation that the fasteners realize over time. Another disadvantage involves the positional placement of the fastener. Most often the placement is left up to the operator and thus the consistency from one placement to another can vary.

### SUMMARY OF THE INVENTION

Accordingly, it is an object of the present invention to improve a bond strength between a fastener and a supporting panel.

It is another object of the present invention to improve a positional placement of a fastener on a supporting panel.

It is still another object of the present invention to easily and efficiently secure wire bundles to a sheet panel.

Additional objects and advantages of the invention will be set forth in part in the description which follows and, in part, will be obvious from the description, or may be learned by practice of the invention.

To achieve the above and other objects of the present inventions, there is provided a fastener to provide an anchor point for a wire and to be fastened to a sheet panel, the fastener including a self-clinching base made of a first material, to self-clinch to the sheet panel, and a fastener section attached to the self-clinching base and made of a second material different from the first material, to secure the wire.

### BRIEF DESCRIPTION OF THE DRAWINGS

The above objects and advantages of the present invention will become more apparent by describing in detail preferred embodiments thereof with reference to the attached drawings in which:

FIG. 1 shows a perspective view of a self-clinching fastener having a metal base according to an embodiment of the present invention;

FIG. 2 shows a side view of the self-clinching fastener shown in FIG. 1;

FIG. 3 shows a side view of a non-flexible self-clinching base shown in FIG. 1 and having a flexible top fastener section which fastens to the self-clinching base;

FIG. 4 shows a perspective view of the self-clinching base shown in FIG. 3;

FIG. 5 shows the side view of the self-clinching base shown in FIG. 2 in greater detail and without the top fastener section;

FIG. 6 shows a perspective view of a self-clinching base according to an aspect of the present invention;

FIG. 7 show a perspective view of a self-clinching fastener having a self-clinching base according to another embodiment of the present invention; and

FIG. 8 shows a side view of the self-clinching fastener shown in FIG. 7.

### DESCRIPTION OF THE PRESENT INVENTION

Reference will now made in detail to the present preferred embodiments of the present invention, examples of which are illustrated in the accompanying drawings, wherein like reference numerals refer to the like elements throughout. The embodiments are described below in order to explain the present invention by referring to the figures.

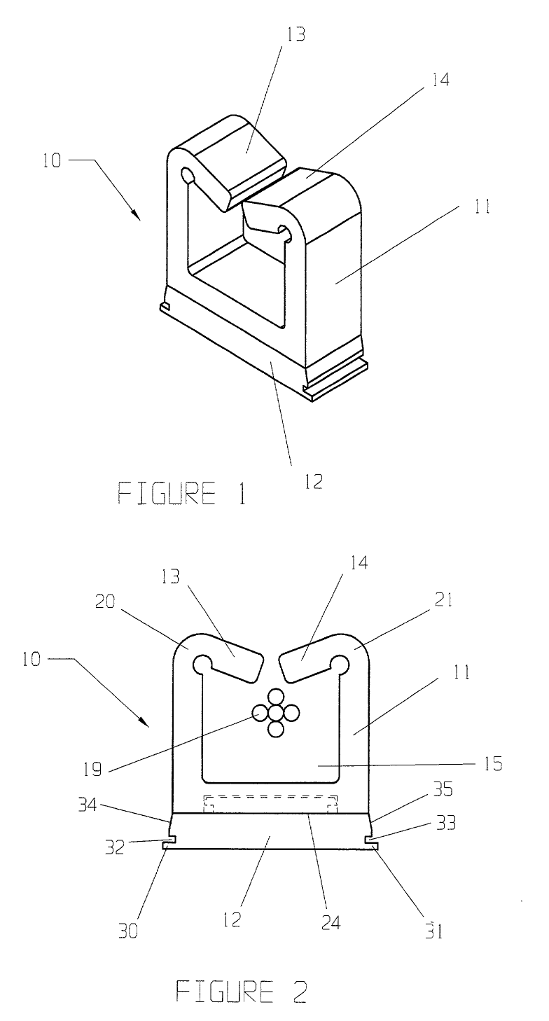

With reference to FIGS. 1 and 2, a self-clinching fastener 10 is shown. The self-clinching fastener 10 includes a base 12 made from a non-flexible material such as a metal and a flexible top fastener section 11 made of a flexible material such as a polymer, like plastic. In this instance, the base may be considered to be a self-clinching base. The top fastener section 11 is molded to the base 12 at an intersection 24 and thus the top fastener section 11 is permanently fastened to the base 12. The base 12 provides for the self-clinching aspects of the present invention. The self-clinching aspects of the base 12 are similar to that described by Winton in U.S. Pat. No. 5,489,175. Winton teaches a self-clinching fastener that displaces material from a surrounding sheet into undercut grooves located on the Winton fastener. This self-clinching process thus bonds the fastener to the surrounding sheet panel. During the self-clinching process, a portion of the surrounding sheet panel cold flows into undercut grooves located on the Winton fastener.

An extended land 30 and an extended land 31 are respectively adjacent to an undercut groove 32 and an undercut groove 33. The undercut groove 32 and the undercut groove 33 are respectively adjacent to a slanted wall 34 and a slanted wall 35.

The top fastener section 11 has a flex arm 13 and a flex arm 14 which form an enclosed area 15. The flex arm 13 pivots about a joint 20 and the flex arm 14 pivots about a joint 21.

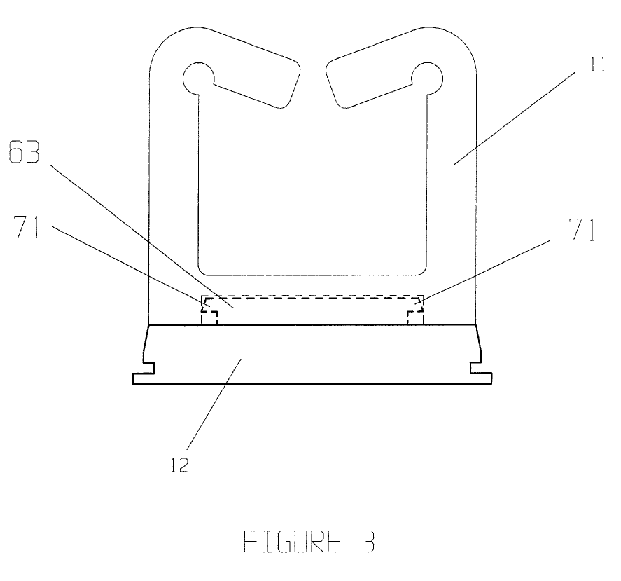

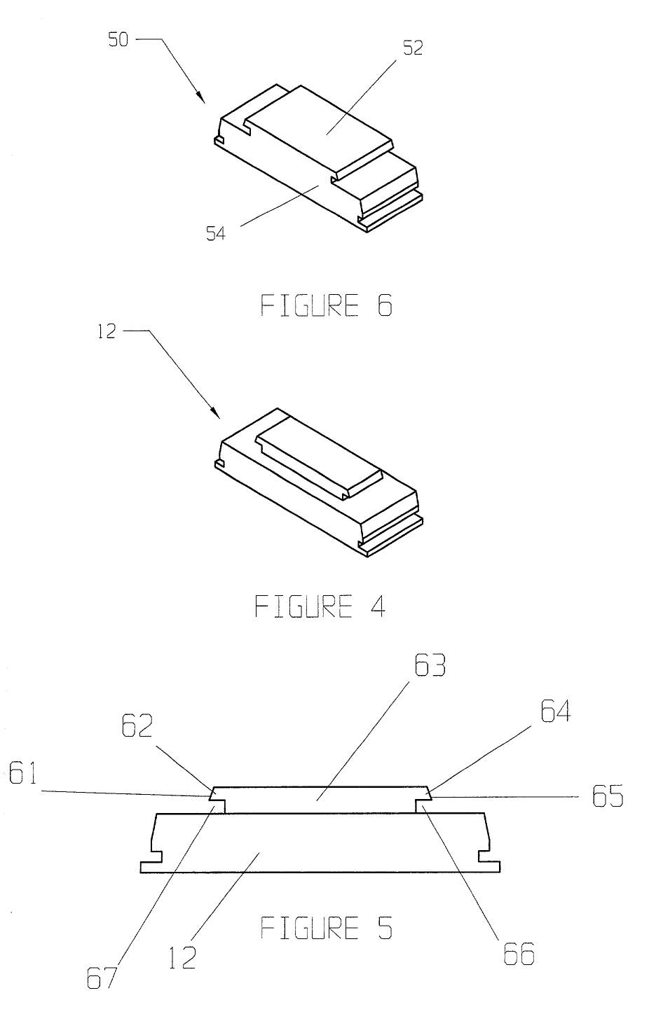

FIG. 3 shows a side view of a non-flexible self-clinching base shown in FIG. 1 and having a flexible top fastener section which fastens to the self-clinching base, and FIG. 4 shows a perspective view of the self-clinching base shown in FIG. 3;

As shown in FIG. 3, a pocket (groove) 71 is formed in a bottom part of the top fastener section 11. In this instance, the pocket has a rectangular cross-section, but does not have to have such a cross-section. Other cross-sections, such as an elliptical cross-section, are possible. As shown in FIG. 5, the base 12 has a union 63. The union 63 has a tang 62 and a tang 64. The tang 62 has a sloping wall 61 and the tang 64 has a sloping wall 65. Below the tang 62 is a recess 67 and below the tang 64 is a recess 66.

As shown in FIGS. 1 and 3, the base 12 is fastened to the top fastener section 11 by a mechanical bonding process. Examples of such a mechanical bonding process include molding, press fitting, and via a snap-action movement. A press fit causes the tangs 62 and 64 to press into the pocket 71. A snap-action fit causes the tangs 62 and 64 to snap into the pocket 71. A molded fit would require that the top fastener section 11 be molded onto the base 12. The sloping walls 61 and 65 are used to guide the top fastener section 11 during the press operation or snap operation. The recesses 67 and 66 provide a relief for all modes of fastening.

A wire or wire bundle 19 is made up of one or more electrical conductors and may or may not have insulation surrounding the conductor(s). The wire bundle 19 is fastened within the enclosed area 15 by the flex arms 13 and 14.

During operation thereof, the self-clinching fastener 10 is first self-clinched into a sheet panel similar in fashion to that described by Winton in U.S. Pat. No. 5,489,175. The wire bundle 19 would then travel in a direction from the flex arms 13 and 14 toward enclosed area 15 (from top to bottom in FIG. 2). As the wire bundle 19 advances toward the enclosed area 15, the flex arms 13 and 14 are displaced downward and thus allow the wire bundle 19 to enter into the enclosed area 15. The flex arm 13 is able to displace toward the enclosed area 15 by rotating about the joint 20, and likewise, the flex arm 14 is able to displace toward the enclosed area 15 by rotating about the joint 21. After the wire bundle 19 is located in the enclosed area 15, it is prevented from leaving the enclosed area 15 due to the large force necessary to deflect the flex arms 13 and 14 in a direction away from the enclosed area 15.

FIG. 6 shows a base 50 according to another aspect of the present invention, and is a variation of the metal base 12 shown in FIG. 4. The base is made of a non-flexible material such as a metal. In this embodiment, a top section 52 of the base 50, which is positioned within the pocket 71 of top fastener section 11 has a width which is the same as the width of a bottom section 54 of the base 50, which performs the self-clinching operation to the supporting sheet panel (not shown).

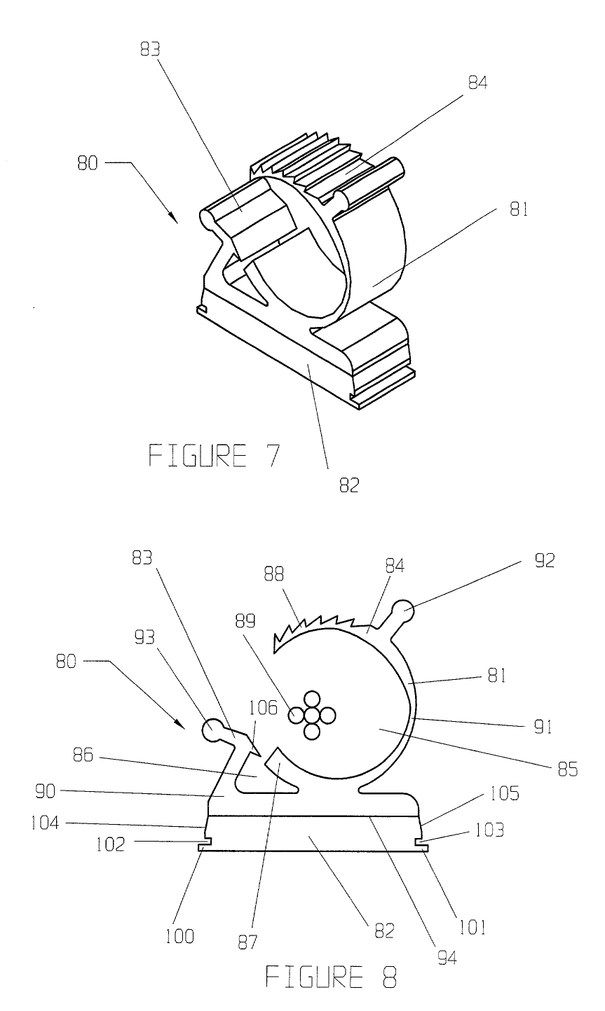

FIGS. 7 and 8 show a self-clinching fastener according to another embodiment of the present invention. A self-clinching fastener 80 is made from a base 92 made of a non-flexible material such as a metal and a top fastener section 81 made of a flexible material such a polymer, like plastic. The top fastener section 81 is fastened to the base 82 at the intersection 94 by a mechanical bonding process like in the previous embodiments shown in FIGS. 1 through 6. As noted above, examples of such a mechanical bonding process include molding, press fitting, and via a snap-action movement. Thus, the top fastener section 81 is permanently fastened to the base 82. The base 82 provides for the self-clinching aspects of the invention, and can be the same as the one shown in FIG. 4 or the one shown in FIG. 6.

An extended land 100 and an extended land 101 are respectively adjacent to an undercut groove 102 and an undercut groove 103. The undercut groove 32 and the undercut groove 33 are respectively adjacent to a slanted wall 34 and a slanted wall 35.

The top fastener section 81 has a flex arm 83 and a flex arm 84 which form an enclosed area 85. The flex arm 83 pivots about a joint 90 and the flex arm 84 pivots about a joint 91.

Teeth 88 and a handle 92 are formed on the flex arm 84. The top fastener section 11 has a thin section 91 formed below the handle 92 and a lower tab 87 that is adjacent to the flex arm 83. The flex arm 83, the joint 90, and the lower tab 87 form an enclosed area 86. A lower handle 93 is joined to the flex arm 83. A tooth 106 is formed on the flex arm 13 and is adjacent to the tab 87.

A wire or wire bundle 89 is made up of one or more electrical conductors and may or may not have insulation surrounding the conductor(s). The wire bundle 89 is fastened within the enclosed area by the flex arms 83 and 84.

During operation thereof, the self-clinching fastener 80 is first self-clinched into a sheet panel (not shown) similar in fashion to that described by Winton in U.S. Pat. No. 5,489,175. The wire bundle 89 is then placed in the enclosed area 55 according to the following operations. After placing the wire bundle 89 inside the enclosed area 85, a slight pressure is applied to the handle 92 in a direction toward the flex arm 83. By applying a slight force to the handle 92, the teeth 88 will advance toward the midpoint between the tooth 106 and the tab 87 by pivoting about the thin section 91. A continued force will cause the teeth 88 to enter the enclosed area 86. While the teeth 88 are being forced to enter the enclosed area 86, the flex arm 13 is displaced in a direction away from the wire bundle 19. The flex arm 83 will temporarily deflect away from the tab 87 by rotating about the joint 90. After the force is removed from the handle 92, the teeth 88 will engage the tooth 106 and the tab 87 and thus the wire bundle 89 will be held within the enclosed area 85.

To release the wire bundle 89 from the enclosed area 85, a slight force is applied to the lower handle 93 in a direction toward the joint 90. This slight force will free the teeth 88 from being captured [is this the correct term?] by the tab 87 and the tooth 106.

The wire fastener according to the present invention is able to maintain its position on a supporting sheet panel, while positioning a wire bundle. Because the base of the wire fastener is made of a non-flexible material such as a metal and has a self-clinching ability, the wire fastener is able to solidly maintain its position with respect to the supporting sheet panel. Because the top fastening section of the wire fastener is made of a flexible material such as a polymer, like plastic, the wire fastener can easily capture and secure a wire bundle, ensuring that the wire bundles stay clear of various devices including moving parts and areas of high temperature and improving the neatness and providing a more visually pleasing apparatus.

Although the present invention has been described with reference to the preferred examples, the foregoing disclosure should be interpreted as illustrative only and it should be understood that various modifications and variations can be easily made by those skilled in the art without departing from the spirit of the invention. Accordingly, a true scope and spirit of the invention should be defined by the following claims.

1. A fastener to provide an anchor point for a wire and to be fastened to a sheet panel, comprising:
a self-clinching base made of a first material, to self-clinch to the sheet panel; and
a fastener section attached to the self-clinching base and made of a second material different from the first material, to secure the wire.

2. The fastener according to claim 1, wherein the fastener section is made of a flexible material.

3. The fastener according to claim 1, wherein the fastener section is made of a polymer.

4. The fastener according to claim 1, wherein:
the base is made of a non-flexible material; and
the fastener section is made of a flexible material and comprises:
a first section attached to the base,
second and third sections extending from the first section,
flexible joints attached at ends of the second and third sections, respectively, and
flex arms extending from the joints, respectively, in a direction of an enclosed area formed by the flex arms, and the first through third sections;
wherein the flex arms flex in the direction of the enclosed area upon pressure of the wire toward the enclosed area, to secure the wire within the enclosed area and prevent the wire from escaping the enclosed area.

5. The fastener according to claim 4, wherein:
the base is made of a metal; and
the fastener section is made of a polymer.

6. The fastener according to claim 1, wherein:
the base comprises:
a first portion with self-clinching lands and grooves, and
a second portion attached to the first portion, wherein the second portion comprises:
tangs extending in opposite directions so as to form respective recesses between the tangs and the first section; and
the fastener section comprises a pocket to receive the second portion, wherein the tangs engage walls of the pocket to affix the fastener section to the base.

7. The fastener according to claim 6, wherein a width of the first portion in a direction perpendicular to the direction in which the tangs extend is the same as a width of the second portion.

8. The fastener according to claim 6, wherein a width of the first portion in a direction perpendicular to the direction in which the tangs extend is less than a width of the second section.

9. The fastener according to claim 4, wherein:
the base comprises:
a first portion with self-clinching lands and grooves, and
a second portion attached to the first portion, wherein the second portion comprises:
tangs extending in opposite directions so as to form respective recesses between the tangs and the first portion; and
the fastener section comprises a pocket to receive the second portion, wherein the tangs engage walls of the pocket to affix the fastener section to the base.

10. The fastener according to claim 9, wherein a width of the first portion in a direction perpendicular to the direction in which the tangs extend is the same as a width of the second portion.

11. The fastener according to claim 9, wherein a width of the first portion in a direction perpendicular to the direction in which the tangs extend is less than a width of the second portion.

12. The fastener according to claim 6, wherein the tangs have sloping walls.

13. The fastener according to claim 9, wherein the tangs have sloping walls.

14. The fastener according to claim 1, wherein:
the base is made of a non-flexible material; and
the fastener section is made of a flexible material and comprises:
a first section attached to the base,
a flex arm attached at a joint to the first section and having a first engaging member and a first handle, and
a receiving member attached to the first section and forming an enclosed area, the receiving member comprising:
a tab;
a non-linear flex arm;
a second handle formed on the flex arm; and
a second engaging member, wherein the tab, non-linear flex arm and second engaging member form an enclosed area;
wherein upon pressure exerted on the second handle, the second engaging unit moves between the tab and the first engaging unit to engage the first engaging unit and secure the wire in the enclosed area, and upon pressure exerted on the first handle, the firs engaging unit disengages from the second engaging unit to enable the wire to be released from the enclosed area.

15. The fastener according to claim 14, wherein:
the base is made of a metal; and
the fastener section is made of a polymer.

16. The fastener according to claim 14, wherein:
the base comprises:
a first portion with self-clinching lands and grooves, and
a second portion attached to the first portion, wherein the second portion comprises:
tangs extending in opposite directions so as to form respective recesses between the tangs and the first portion; and
the fastener section comprises a pocket to receive the second portion, wherein the tangs engage walls of the pocket to affix the fastener section to the base.

17. The fastener according to claim 16, wherein a width of the first portion in a direction perpendicular to the direction in which the tangs extend is the same as a width of the second portion.

18. The fastener according to claim 16, wherein a width of the first portion in a direction perpendicular to the direction in which the tangs extend is less than a width of the second portion.

19. The fastener according to claim 16, wherein the tangs have sloping walls.

20. The fastener according to claim 6, wherein a cross-section of the pocket is rectangular.

21. The fastener according to claim 16, wherein a cross-section of the pocket is rectangular.

22. The fastener according to claim 6, wherein the tangs are press-fit into the pocket.

23. The fastener according to claim 6, wherein the tangs are snap-action fitted into the pocket.

24. The fastener according to claim 1, wherein the fastener section is molded to the base.

25. The fastener according to claim 16, wherein the tangs are press-fit into the pocket.

26. The fastener according to claim 16, wherein the tangs are snap-action fitted into the pocket.

27. The fastener according to claim 1, wherein the fastener section is molded to the base.

28. A fastener to provide an anchor point for a wire and to be fastened to a sheet panel, comprising:
a non-flexible self-clinching base, to self-clinch to the sheet panel; and
a flexible fastener section attached to the self-clinching base, to secure the wire.

29. The fastener according to claim 28, wherein:
the self-clinching base is made of a metal; and
the fastener section is made of a polymer.

30. The fastener according to claim 28, wherein the fastener section is permanently affixed to the self-clinching base.

31. The fastener according to claim 29, wherein the fastener section is permanently affixed to the self-clinching base.

32. A fastener to provide an anchor point for a wire and to be fastened to a sheet panel, comprising:
a metal self-clinching base, to self-clinch to the sheet panel; and
a polymer fastener section attached to the self-clinching base, to secure the wire.
